(19) United States
(12) Patent Application Publication
(10) Pub. No.: US 2016/0270131 A1
(43) Pub. Date: Sep. 15, 2016

(54) WIRELESS COMMUNICATION APPARATUS, METHOD OF CONTROLLING WIRELESS COMMUNICATION APPARATUS, AND WIRELESS COMMUNICATION SYSTEM

(71) Applicant: FUJITSU LIMITED, Kawasaki-shi (JP)

(72) Inventor: Tetsuya Hasegawa, Kawasaki (JP)

(73) Assignee: FUJITSU LIMITED, Kawasaki-shi (JP)

(21) Appl. No.: 15/050,938

(22) Filed: Feb. 23, 2016

(30) Foreign Application Priority Data
Mar. 9, 2015 (JP) 2015-046247

(51) Int. Cl. H04W 76/02; H04W 36/00; H04W 4/00

(52) U.S. Cl. CPC H04W 76/02; H04W 4/005; H04W 36/0016

(57) ABSTRACT

A wireless communication apparatus is adapted to provide a wireless area, and includes an inferencer and a controller. The inferencer is adapted to infer a type of a terminal device that is requesting a new connection, based on information obtained through a previous connection in the wireless area. The controller is adapted to control a communication with the terminal device based on the inferred type.

### CROSS-REFERENCE TO RELATED APPLICATION

This application is based upon and claims the benefit of priority of the prior Japanese Patent application No. 2015-046247, filed on Mar. 9, 2015, the entire contents of which are incorporated herein by reference.

### FIELD

The present disclosure relates to a wireless communication apparatus, a method of controlling a wireless communication apparatus, and a wireless communication system.

### BACKGROUND

A wireless communication system has been well known which includes a wireless communication apparatus adapted to provide a wireless area and multiple terminal devices adapted to be connected to the wireless communication apparatus in the wireless area, to wirelessly communicate with the wireless communication apparatus.

Some types of terminal devices operate without requiring any interventions by users. Terminal devices in such types are known as machine-to-machine (M2M) devices, or internet of things (IoT) devices.

Examples of M2M devices include surveillance cameras, lighting devices, and air conditioners installed in houses, for example. In such cases, wireless communications are carried out in order to detect comings and goings of residents to and from a house with a surveillance camera and to control a lighting device and air conditioner in accordance with detection results, for example.

Other examples of M2M devices include vending machines for selling products and manufacturing machines for manufacturing these products, for example. In such cases, wireless communications are carried out in order to tally the product sales of a vending machine and to control a manufacturing machine in accordance with the tallied result, for example.

For example, the wireless communication apparatus disclosed in Patent Document 1 infers the type of a terminal device that is newly connected, based on version information in a MAC header contained in a resource reservation request received from that terminal device. The wireless communication apparatus then controls communications with that terminal device based on the inferred type. The term “MAC” is the abbreviation for the Medium Access Control.

Patent Document 1: Japanese Laid-open Patent

Publication No. 2007-266719

### SUMMARY

In the meantime, under some non-WiMAX communication standards, no MAC header is sent. The term “WiMAX” is the abbreviation for the Worldwide Interoperability for Microwave Access. In such cases, a wireless communication apparatus can not infer the types of terminal devices. As a result, efficient wireless communications may not be achieved.

In one aspect, a wireless communication apparatus is adapted to provide a wireless area, and includes an inferencer and a controller. The inferencer is adapted to infer a type of a terminal device that is requesting a new connection, based on information obtained through a previous connection in the wireless area. The controller is adapted to control a communication with the terminal device based on the inferred type.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a graph indicating one example of a change in communication volumes over time when a terminal device is a mobile telephone;

FIG. 2 is a graph indicating one example of a change in communication volumes over time when a terminal device is an M2M device;

FIG. 3 is a block diagram illustrating one example of a configuration of a wireless communication system in accordance with a first embodiment;

FIG. 4 is a block diagram illustrating one example of a configuration of a wireless communication apparatus in FIG. 3;

FIG. 5 is a block diagram illustrating one example of a configuration of a terminal device in FIG. 3;

FIG. 6 is a block diagram illustrating one example of a configuration of the controller in FIG. 3;

FIG. 7 is a block diagram illustrating one example of functions of a wireless communication apparatus in FIG. 3;

FIG. 8 is a sequence chart illustrating one example of a procedure executed by the wireless communication system in FIG. 3 for connecting a terminal device and a wireless communication apparatus;

FIG. 9 is a table indicating one example of connection cause information;

FIG. 10 is a sequence chart illustrating one example of a procedure executed by the wireless communication system in FIG. 3 for achieving a handover (HO) for a terminal device, based on an HO request from the controller;

FIG. 11 is a table indicating one example of history information;

FIG. 12 is a sequence chart illustrating one example of a procedure executed by the wireless communication system in FIG. 3 for disconnecting a connection between a wireless communication apparatus and a terminal device;

FIG. 13 is a sequence chart illustrating one example of a procedure executed by the wireless communication system in FIG. 3 for disconnecting a connection between a wireless communication apparatus and a terminal device;

FIG. 14 is a table indicating one example of the number of history information for each of combinations of cells, obtained by a wireless communication apparatus in FIG. 3;

FIG. 15 is a table indicating one example of the number of HO disconnections, the total number of disconnections, the HO disconnection ratio, and the round-trip HO ratio, obtained by a wireless communication apparatus in FIG. 3;

FIG. 16 is a table indicating one example of wireless parameters, used by a wireless communication apparatus in FIG. 3 for controlling communications with a terminal device;

FIG. 17 is a sequence chart illustrating one example of a procedure executed by the wireless communication system in FIG. 3, for setting wireless parameters to a terminal device;

FIG. 18 is a flowchart illustrating one example of processing executed by a wireless communication apparatus in FIG. 3, for inferring the type of a terminal device, and for controlling communications with the terminal device;

FIG. 19 is a diagram illustrating one example of connections between the wireless communication apparatuses and the terminal devices in the wireless communication system in FIG. 3;

FIG. 20 is a diagram illustrating one example of connections between the wireless communication apparatus and the terminal devices in the wireless communication system in FIG. 3;

FIG. 21 is a table indicating one example of the number of history information for each of combinations of cells, obtained by a wireless communication apparatus in FIG. 3;

FIG. 22 is a table indicating one example of the number of HO disconnections, the total number of disconnections, the HO disconnection ratio, and the round-trip HO ratio, obtained by a wireless communication apparatus in FIG. 3;

FIG. 23 is a table indicating one example of the number of HO disconnections, the total number of disconnections, the HO disconnection ratio, and the round-trip HO ratio, obtained by a wireless communication apparatus in FIG. 3;

FIG. 24 is a flowchart illustrating one example of processing executed by a wireless communication apparatus of a second embodiment, for inferring the type of a terminal device, and for controlling communications with the terminal device;

FIG. 25 is a flowchart illustrating one example of processing executed by a wireless communication apparatus of a third embodiment, for inferring the type of a terminal device, and for controlling communications with the terminal device;

FIG. 26 is a diagram illustrating one example of a time duration during which terminal devices carry out communications and a time duration during which the terminal devices carry out no communication; and

FIG. 27 is a flowchart illustrating one example of processing executed by a wireless communication apparatus of a fourth embodiment, for inferring the type of a terminal device, and for controlling communications with the terminal device.

### DESCRIPTION OF EMBODIMENTS

Hereinafter, embodiments will be described with reference to the drawings. It is to be noted that embodiments described below are exemplary. Thus, applications of various modifications and techniques to the embodiments are not excluded. It is to be noted elements that are referenced to by the like reference symbols denote the same or similar elements in the drawings referenced to in the embodiments described below, unless any modifications or variations are explicitly specified.

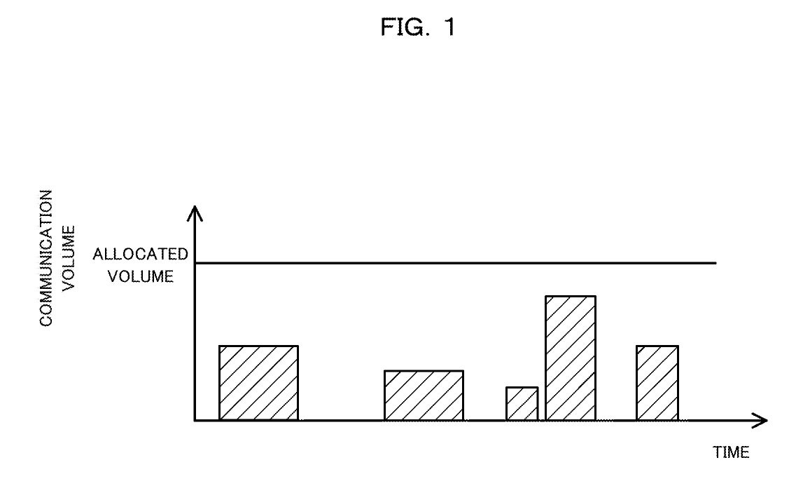

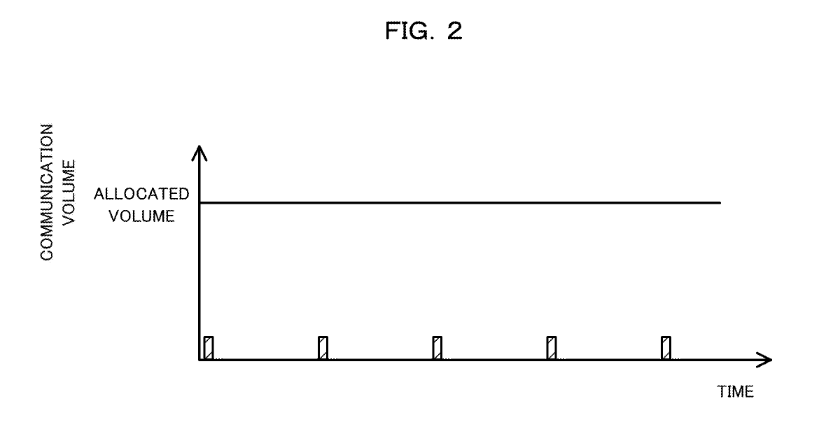

FIGS. 1 and 2 indicate examples of changes in data volumes (i.e., communication volumes) communicated between a wireless communication apparatus and a terminal device over time, when the terminal device is a mobile telephone and when the terminal device is an M2M device, respectively. The mobile telephone may also be referred to as a non-M2M device.

A user using the mobile telephone may use data in a relatively large size for a relatively long time, for watching a video or executing an application program.

In contrast, the M2M device may send sensor data, at regular intervals or in response to instructions from an external apparatus. Examples of the sensor data include temperatures, humidity, accelerations, illuminance, wind directions, wind velocities, seismic vibrations, rainfalls, sound volumes, water levels, power consumptions, water consumptions, gas consumptions, captured images or videos, product sales quantities, and the like.

As depicted in FIG. 1, when the terminal device is a mobile telephone, the communication volume fluctuates irregularly. The terminal device that is a mobile telephone communicates data on the order of several megabytes, for example. The terminal device that is a mobile telephone communicates for the durations ranging from several minutes to several dozens of minutes, for example.

On the contrary, as depicted in FIG. 2, when the terminal device is an M2M device, the communication volume changes regularly. The terminal device that is an M2M device communicates data on the order of kilobytes, for example. The terminal device that is an M2M device communicates for the durations ranging from several millisecond to several seconds.

Hence, communication volumes of a terminal device that is a mobile telephone are generally greater than those of a terminal device that is an M2M device, and durations of communications of a terminal device that is a mobile telephone are generally longer than those of a terminal device that is an M2M device.

As depicted in FIG. 1, the communication volume of a mobile telephone often fluctuates significantly. Accordingly, a wireless communication apparatus allocates sufficient wireless resources to mobile telephones. In this example, a communication volume of a wireless resource allocated to a terminal device is referred to as an allocated volume.

As indicated from FIG. 2, if a wireless resource is allocated to an M2M device in the manner similar to a mobile telephone, the ratio of a wireless resource that is actually used for communications to the allocated wireless resource would be low. Stated differently, an excess volume of a wireless resource tends to be allocated.

In the meantime, under communication schemes stipulated by the 3GPP, no MAC header is sent. The term “3GPP” is the abbreviation for the Third Generation Partnership Project. Hence, it is not possible to determine the type of a terminal device based on the version information of a MAC header.

Furthermore, when a terminal device requests a new connection, it is possible to initially allocate a wireless resource in a relatively small volume and to increase the wireless resource gradually afterward. However, in this case, when a burst traffic arises which is often experienced by a mobile telephone, the wireless resource may become insufficient, resulting in a disconnection of the connection. For example, a burst traffic represents a surge in the communication volume.

### First Embodiment

(Configuration)

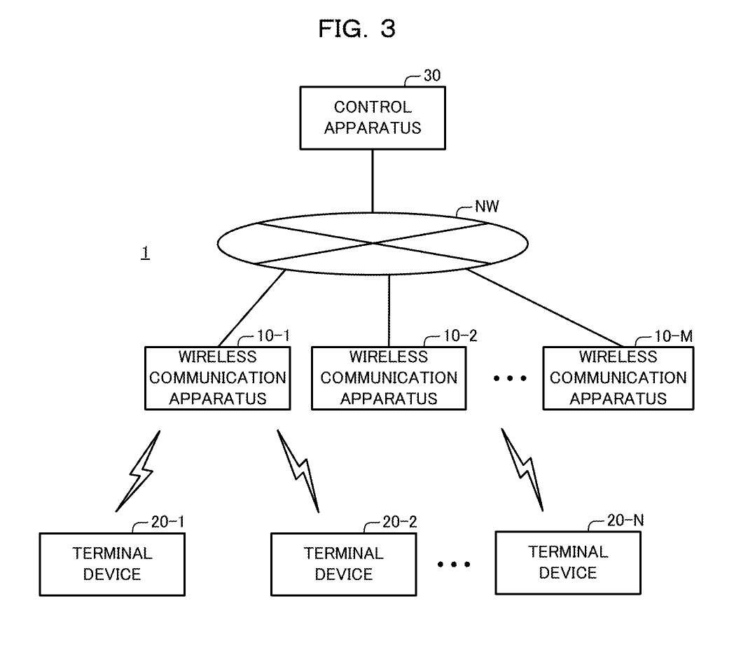

Referring to FIG. 3, a wireless communication system 1 in accordance with a first embodiment exemplarily includes M wireless communication apparatuses 10-1, 10-2, . . . , and 10-M; N terminal devices 20-1, 20-2, . . . , and 20-N; and a control apparatus 30.

In this example, M represents an integer of 2 or greater. Hereinafter, the wireless communication apparatuses 10-m are also referred to as the wireless communication apparatuses 10 when no distinction is to be made among them. Here, m represents each integer from 1 to M. In this example, N represents an integer of 2 or greater. Hereafter, the terminal devices 20-n are also referred to as the terminal devices 20, when no distinction is to be made among them. Here, n represents each integer from 1 to N.

The wireless communication system 1 carries out wireless communications between the wireless communication apparatuses 10-m and the terminal devices 20-n, in accordance with a certain communication scheme. The communication scheme is the LTE scheme, for example. The term “LTE” is the abbreviation for the Long Term Evolution. It is to be noted that the communication scheme may be a communication scheme different from the LTE scheme (e.g., the LTE-Advanced and the like).

The wireless communication apparatuses 10-m form wireless areas. The wireless communication apparatuses 10-m may form multiple wireless areas. The wireless areas may be referred to as coverage areas or communication areas. The wireless areas may also be referred to as cells. The cells may be macro cells, micro cells, nano cells, pico cells, femto cells, home cells, small cells, sector cells, or the like, for example.

Each wireless communication apparatus 10-m wirelessly communicates with a terminal device 20-n located in the area formed by that the wireless communication apparatus 10-m.

In this example, each wireless communication apparatus 10-m provides a wireless resource in the area formed by that the wireless communication apparatus 10-m. In this example, each wireless resource is identified with time and the frequency. Each wireless communication apparatus 10-m carries out communications with a terminal device 20-n located the area formed by that the wireless communication apparatus 10-m, employing a wireless resource provided by the wireless communication apparatus 10-m in that cell.

In this example, when receiving a connection request from a terminal device 20-n located in the area formed by a wireless communication apparatus 10-m, the wireless communication apparatus 10-m connects the terminal device 20-n to that wireless communication apparatus 10-m. A connection request is information requesting a connection to the wireless communication apparatus 10-m.

Furthermore, in this example, when receiving a handover (HO) request from a control apparatus 30 or another wireless communication apparatus 10-p, a wireless communication apparatus 10-m connects a terminal device 20 specified in the HO request to that wireless communication apparatus 10-m. Here, p is an integer from 1 to M, and is not equal to m. An HO request is information including information specifying a terminal device 20, and requesting to change the connection destination of the specified terminal device 20 to the requested wireless communication apparatus 10-m.

A wireless communication apparatus 10-m sends and receives data signals to and from a terminal device 20-n connecting to that wireless communication apparatus 10-m. For example, data signals represent any data (e.g., user data).

In this example, a wireless communication apparatus 10-m disconnects a connection to a terminal device 20-n connected to that wireless communication apparatus 10-m, when the time duration during which no communication is carried out with the terminal device 20-n exceeds a certain threshold. Further, in this example, the wireless communication apparatus 10-m also disconnects a connection to a terminal device 20-n connected to that wireless communication apparatus 10-m, when the quality of a communication with that terminal device 20-n is lower than a certain threshold.

The wireless communication apparatus 10-m determines whether or not to execute an HO for a terminal device 20-n, based on a measurement report from that terminal device 20-n. In this example, the measurement report represents results of measurements of the quality of a communication between the wireless communication apparatus 10-m and the terminal device 20-n that are connected, and qualities of communications between another wireless communication apparatus 10-p and the terminal device 20-n.

When the wireless communication apparatus 10-m determines that an HO is to be executed, the wireless communication apparatus 10-m sends an HO request to the control apparatus 30 or another wireless communication apparatus 10-p and sends an HO instruction to the terminal device 20-n. An HO instruction is information instructing an execution of an HO.

It is to be noted that the wireless communication apparatus 10-m may also be referred to as a base station, an eNB (Evolved Node B), or an NB (Node B).

In this example, as depicted in FIG. 3, the wireless communication apparatuses 10-m are communicatively connected to a communication network (e.g., core network) NW through wire connections. Note that the wireless communication apparatuses 10-m may be communicatively connected to the communication network NW wirelessly, instead of through the wire connections. The interface between the wireless communication apparatuses 10-m and the communication network NW may be referred to as an S1 interface. The interfaces among the wireless communication apparatuses 10 may be referred to as an X2 interface.

The part of the wireless communication system 1 closer to the communication network NW than the wireless communication apparatus 10 (i.e., the upstream part of the wireless communication system 1) may be referred to as the EPC. The term “EPC” is the abbreviation for the Evolved Packet Core. The part of the wireless communication system 1 defined by the wireless communication apparatuses 10 may be referred to as the E-UTRAN. The term “E-UTRAN” is the abbreviation for the Evolved Universal Terrestrial Radio Access Network.

The terminal devices 20-n wirelessly communicate with the wireless communication apparatuses 10-m using wireless resources provided in cells where those terminal devices 20-n reside.

In this example, a terminal device 20-n is connected to a wireless communication apparatus 10-m forming a cell where that terminal device 20-n resides, by sending and receiving a certain control signal to and from that wireless communication apparatus 10-m. Further, in this example, when a terminal device 20-n is connected to a wireless communication apparatus 10-m, that terminal device 20-n sends and receives a data signal to and from the wireless communication apparatus 10-m.

It is to be noted that the terminal devices 20-n may also be referred to as wireless terminals, wireless devices, wireless apparatuses, or a user equipment (UE). In this example, the terminal devices 20-n are M2M devices, mobile telephones, or the like. One example of mobile telephones is a smartphone. One example of M2M devices is a sensor or a meter. The M2M devices may be referred to as internet of things (IoT) devices.

The terminal devices 20-n may be carried by users, may be within moving objects, e.g., vehicles, or may be stationary. In this example, when a terminal device 20-n is a mobile telephone, the terminal device 20-n is carried by a user. In other words, when a terminal device 20-n is a mobile telephone, the terminal device 20-n may be moved. In this example, when a terminal device 20-n is an M2M device, the terminal device 20-n is stationary (i.e., is not be moved).

The control apparatus 30 is communicatively connected to the communication network NW through a wired connection. In this example, the control apparatus 30 is communicatively connected to each wireless communication apparatus 10 through the communication network NW. The control apparatus 30 may also be referred to as the control station, the management apparatus, the control server, or the management server. Note that the control apparatus 30 may also be referred to as the mobility management entity (MME) or the home subscriber server (HSS). The control apparatus 30 may be configured from multiple apparatuses.

(Configuration; Wireless Communication Apparatus 10)

Next, a configuration of a wireless communication apparatus 10 will be described.

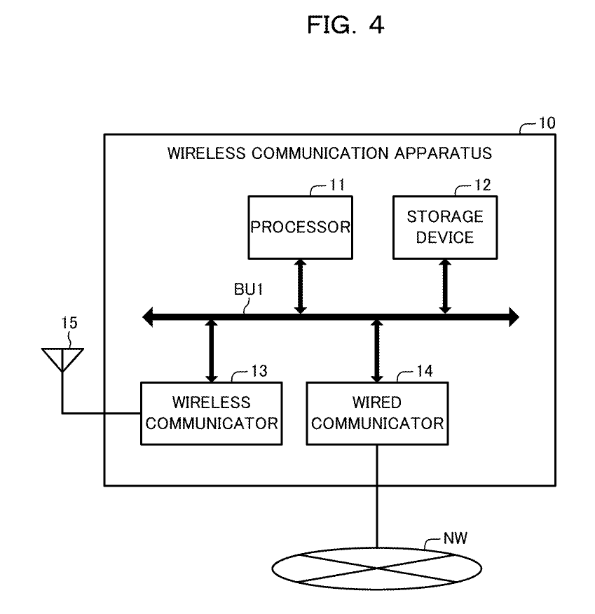

Referring to FIG. 4, a wireless communication apparatus 10 exemplarily includes a processor 11, a storage device 12, a wireless communicator 13, and a wired communicator 14, which are connected to each other via a bus BU1.

The processor 11 controls elements in the wireless communication apparatus 10 for realizing functions that will be described below. In this example, the processor 11 is a central processing unit (CPU). In this example, the processor 11 realizes the functions described later, by executing a program stored in the storage device 12.

It is to be noted that the functions of the processor 11 may be realized by a large scale integration (LSI) or a programmable logic device (PLD).

The storage device 12 includes at least one an RAM, an ROM, a HDD, an SSD, a semiconductor memory, and an organic memory, for example. The term “RAM” is the abbreviation for a random access memory. The term “ROM” is the abbreviation for a read only memory. The term “HDD” is the abbreviation for a hard disk drive. The term “SSD” is the abbreviation for a solid state drive.

The storage device 12 includes a volatile memory and a non-volatile memory, for example. Note that the storage device 12 may include a storage medium, e.g., a flexible disk, an optical disk, a magneto-optic disk, and a semiconductor memory, and a reader that is capable of reading information from the storage medium.

The wireless communicator 13 includes an antenna 15, and carries out communications with a terminal device 20 located in a cell formed through the antenna 15, in accordance with the above-described communication scheme. In this example, the functions of the wireless communicator 13 are realized by executing a program stored in a digital signal processor (DSP) in advance. Note that the functions of the wireless communicator 13 may be realized by an LSI.

The wired communicator 14 includes a communication port to which a communication cable can be connected, and carries out communications with other apparatuses (e.g., the control apparatus 30) that are connected to the communication network NW in accordance with a wired LAN scheme, when the wired communicator 14 is connected to the communication network NW through a communication cable. The wired LAN scheme is one of the standards of the IEEE 802.3 series, for example. The wired LAN scheme represents one example of a wired communication scheme. The wired LAN scheme may be the Ethernet® standard, for example.

(Configuration; Terminal Device 20)

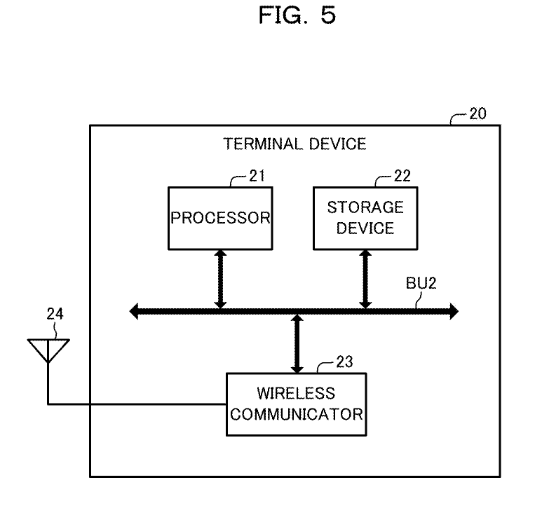

Referring to FIG. 5, a terminal device 20 exemplarily includes a processor 21, a storage device 22, and a wireless communicator 23, which are connected to each other via a bus BU 2.

The processor 21 has functions similar to those of the processor 11. The storage device 22 has functions similar to those of the storage device 12.

The wireless communicator 23 includes an antenna 24, and through the antenna 24, carries out communications with a wireless communication apparatus 10 forming a cell where the terminal device 20 having this wireless communicator 23 resides, in accordance with the above-described communication scheme.

(Configuration; Control Apparatus 30)

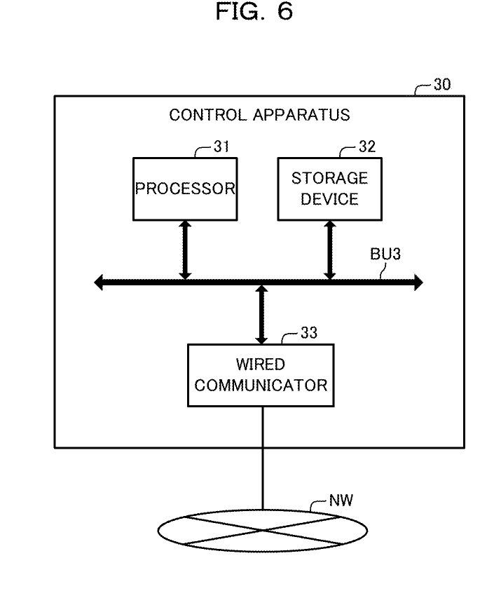

Referring to FIG. 6, the control apparatus 30 exemplarily includes a processor 31, a storage device 32, and a wired communicator 33, which are connected to each other via a bus BU3.

Similarly to the processor 11, the processor 31 controls elements in the control apparatus 30 for realizing functions that will be described below. The storage device 32 has functions similar to those of the storage device 12.

The wired communicator 33 has functions similar to those of the wired communicator 14, and carries out communications with other apparatuses (e.g., the wireless communication apparatus 10) that are connected to the communication network NW in accordance with a wired LAN scheme, when the wired communicator 33 is connected to the communication network NW through a communication cable.

(Function; Wireless Communication Apparatus 10)

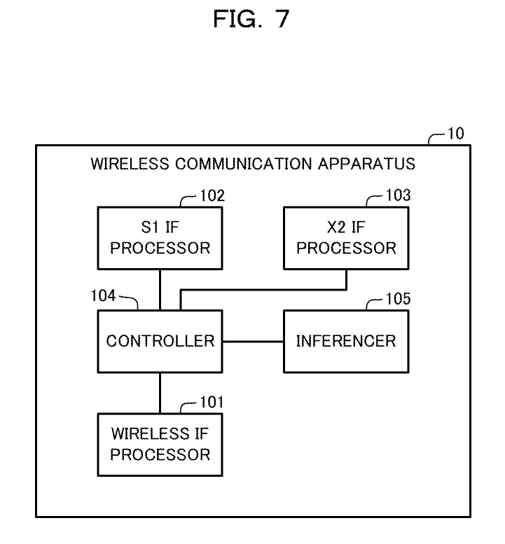

Next, functions of a wireless communication apparatus 10 will be described. Referring to FIG. 7, the functions of a wireless communication apparatus 10 exemplarily include a wireless interface (IF) processor 101, an S1 IF processor 102, an X2 IF processor 103, a controller 104, and an inferencer 105.

The wireless IF processor 101 sends and receives a control signal (i.e., a message) for connecting a terminal device 20 to that wireless IF processor 101, to and from that terminal device 20 in accordance with the above-described communication scheme. In this example, the wireless IF processor 101 sends and receives a control signal in accordance with the Radio Resource Control (RRC) protocol.

The wireless IF processor 101 sends and receives a data signal to and from a terminal device 20 that is connected to that wireless IF processor 101, in accordance with the above-described communication scheme.

The S1 IF processor 102 communicates with the control apparatus 30 in accordance with the above-described communication scheme. For example, the S1 IF processor 102 sends the control apparatus 30, information for identifying a terminal device 20 that is newly connected to the wireless IF processor 101, and information for identifying a terminal device 20 a connection to which has been disconnected.

Further, the S1 IF processor 102 sends an HO request to the control apparatus 30. In this case, the wireless communication apparatus 10 having this S1 IF processor 102 functions as an HO-source apparatus. The S1 IF processor 102 receives the HO request from the control apparatus 30. In this case, the wireless communication apparatus 10 having this S1 IF processor 102 functions as an HO-destination apparatus.

The X2 IF processor 103 communicates with a wireless communication apparatus 10 (i.e., another wireless communication apparatus 10) different from the wireless communication apparatus 10 having that X2 IF processor 103, in accordance with the above-described communication scheme. For example, the X2 IF processor 103 sends an HO request to another wireless communication apparatus 10. In this case, the wireless communication apparatus 10 having this X2 IF processor 103 functions as an HO-source apparatus. The X2 IF processor 103 receives an HO request from another wireless communication apparatus 10. In this case, the wireless communication apparatus 10 having this X2 IF processor 103 functions as an HO-destination apparatus.

The controller 104 processes a message received through the wireless IF processor 101, the S1 IF processor 102, and the X2 IF processor 103. The controller 104 also controls a message to be sent through the wireless IF processor 101, the S1 IF processor 102, and the X2 IF processor 103.

The controller 104 controls communications with a terminal device 20 that is newly connected to the wireless IF processor 101, based on a result of an inference by the inferencer 105 (described later). The control by the controller 104 based on the result of an inference by the inferencer 105 will be described later.

The inferencer 105 obtains connection information in a cell formed by the wireless communication apparatus 10 having this inferencer 105. In this example, the connection information is the information about connections between the wireless IF processor 101 and a terminal devices 20 in the cell. The inferencer 105 infers the type of a terminal device 20 requesting a new connection, based on connection information obtained for previous connections. In this example, the type of terminal devices 20 is one of a mobile telephone and an M2M device.

Hereinafter, an obtainment of connection information will be described, and then an inference of the type of a terminal device 20 will be described.

(Obtainment of Connection Information)

In this example, the inferencer 105 obtains connection information, based on connection cause information indicating the cause of a connection, disconnection cause information indicating a cause of a disconnection, history information indicating a history of a cell to which a terminal device 20 is connected.

An obtainment of connection cause information will be described.

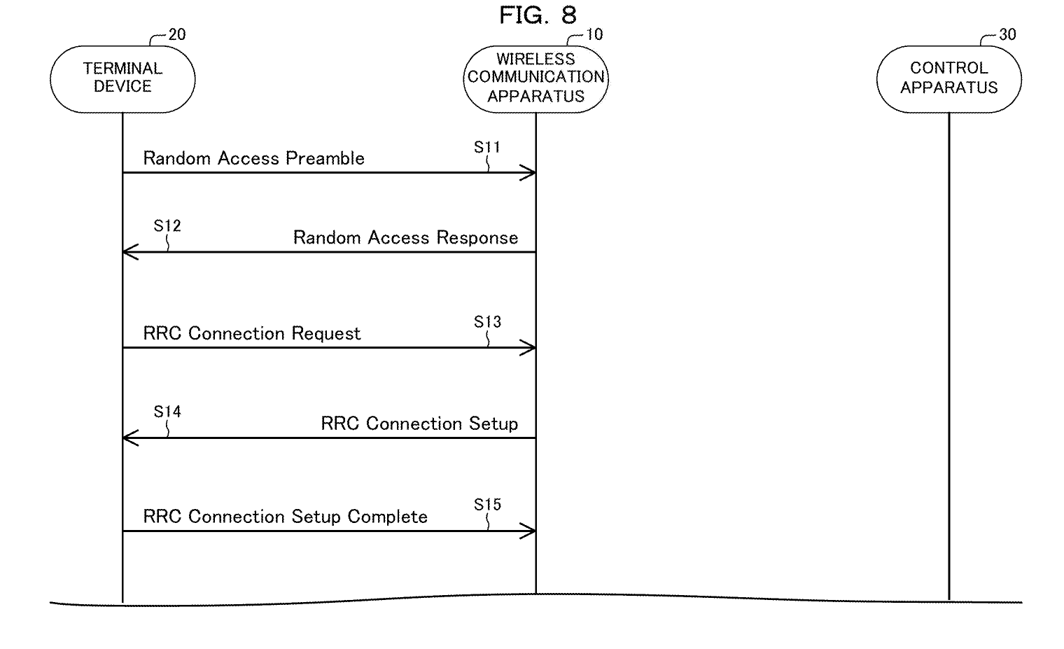

In this example, in the wireless communication system 1, a terminal device 20 is connected to a wireless communication apparatus 10 with an execution of the procedure depicted in FIG. 8.

In this example, the terminal device 20 sends a Random Access Preamble message to the wireless communication apparatus 10 (Step S11 in FIG. 8).

The wireless communication apparatus 10 sends a Random Access Response message to the terminal device 20 (Step S12 in FIG. 8).

The terminal device 20 sends an RRC Connection Request message to the wireless communication apparatus 10 (Step S13 in FIG. 8). In this example, RRC Connection Request message includes connection cause information. The connection cause information may be the parameter known as the “EstablishmentCause”.

Sending an RRC Connection Request message by a terminal device 20 to a wireless communication apparatus 10 represents one example of the terminal device 20 requesting a new connection to the wireless communication apparatus 10. In this example, a terminal device 20 requesting a new connection to the wireless communication apparatus 10 may be a terminal device 20 that has never been connected to the wireless communication apparatus 10, or may be a terminal device 20 that was connected to the wireless communication apparatus 10 in the past but the connection was disconnected.

The wireless communication apparatus 10 sends an RRC Connection Setup RRC Connection Setup message to the terminal device 20 (Step S14 in FIG. 8).

The terminal device 20 sends an RRC Connection Setup Complete message to the wireless communication apparatus 10 (Step S15 in FIG. 8).

In this manner, the connection of the terminal device 20 to the wireless communication apparatus 10 is completed.

In this example, every time an RRC Connection Request message is received from a terminal device 20, the inferencer 105 obtains connection cause information included in the received message.

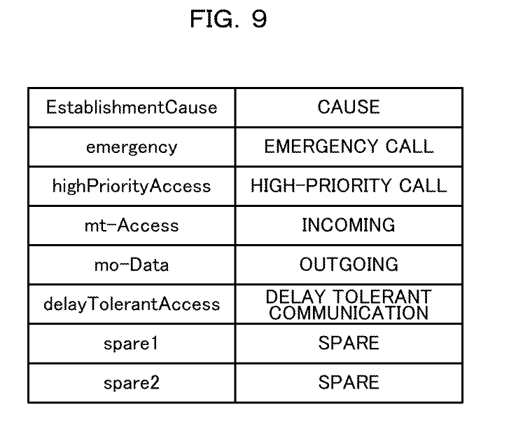

The “EstablishmentCause” has a predetermined value for each cause, as depicted in FIG. 9. The “EstablishmentCause” in the RRC Connection Request message assuming a value of the “delayTolerantAccess” represents one example of a cause of a connection being a delay tolerant access.

An obtainment of history information will be described.

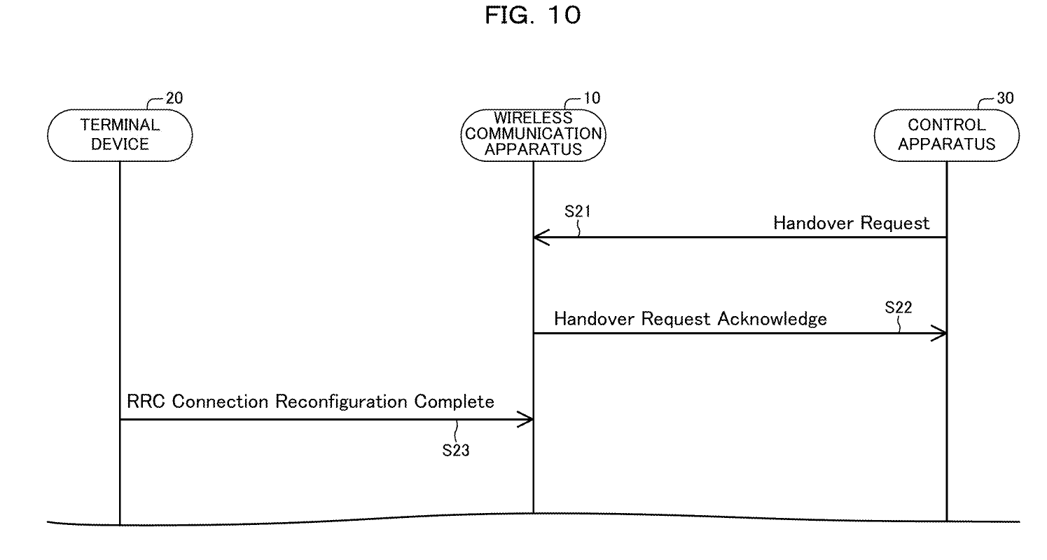

In this example, in the wireless communication system 1, a wireless communication apparatus 10 executes an HO for a terminal device 20 based on an HO request from the control apparatus 30, with an execution of the procedure depicted in FIG. 10.

In this example, the control apparatus 30 sends a Handover Request message to the wireless communication apparatus 10 (Step S21 in FIG. 10).

In this example, the Handover Request message includes history information. The history information may also be referred to as the UE History Information.

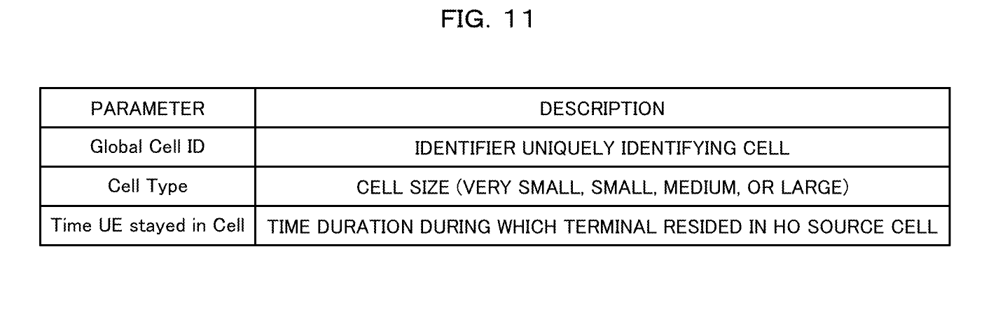

In this example, the history information is a cell identifier for identifying a cell, a cell type indicating the type of the cell (e.g., the size of the cell), and a stay time indicating how long the terminal device 20 has been connected to the cell. As depicted in FIG. 11, the cell identifier, the cell type, and the stay time may be denoted as the “Global Cell ID”, the “Cell Type”, and the “Time UE stayed in Cell”, respectively.

The wireless communication apparatus 10 sends a Handover Request Acknowledge message to the control apparatus 30 (Step S22 in FIG. 10).

The terminal device 20 sends an RRC Connection Reconfiguration Complete message to the wireless communication apparatus 10 (Step S23 in FIG. 10).

In this manner, the execution of an HO for the terminal device 20 based on the HO request from the control apparatus 30 is completed.

It is to be noted that the wireless communication system 1 operates similarly when a wireless communication apparatus 10 receives an HO request from another wireless communication apparatus 10, not from the control apparatus 30.

In this example, every time a Handover Request message is received from another wireless communication apparatus 10 or the control apparatus 30, the inferencer 105 obtains history information included in the received message.

An obtainment of disconnection cause information will be described.

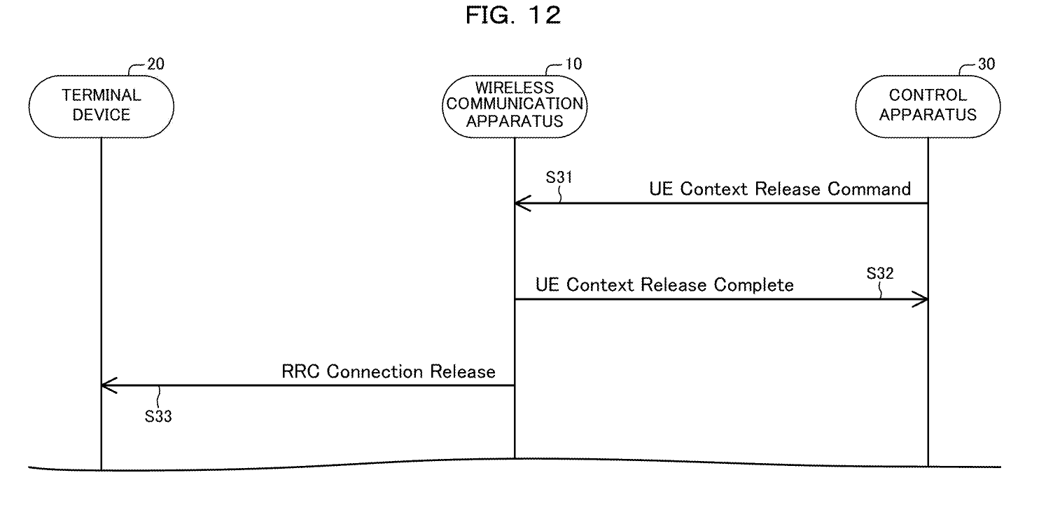

In this example, in the wireless communication system 1, a wireless communication apparatus 10 disconnects a connection to a terminal device 20 in response to an instruction from the control apparatus 30, with an execution of the procedure depicted in FIG. 12.

In this example, the control apparatus 30 sends a UE Context Release Command message to the wireless communication apparatus 10 (Step S31 in FIG. 12). In this example, the UE Context Release Command message includes disconnection cause information. When the cause of the disconnection is an HO, the disconnection cause information indicates the HO. In this example, the disconnection cause information indicates the “Successful HO”, in this case.

The wireless communication apparatus 10 sends a UE Context Release Complete message to the control apparatus 30 (Step S32 in FIG. 12).

The wireless communication apparatus 10 sends an RRC Connection Release message to the terminal device 20 (Step S33 in FIG. 12).

In this manner, the disconnection of the connection by the wireless communication apparatus 10 based on an instruction from the control apparatus 30 is completed.

In this example, every time a UE Context Release Command message is received from the control apparatus 30, the inferencer 105 obtains disconnection cause information included in the received message.

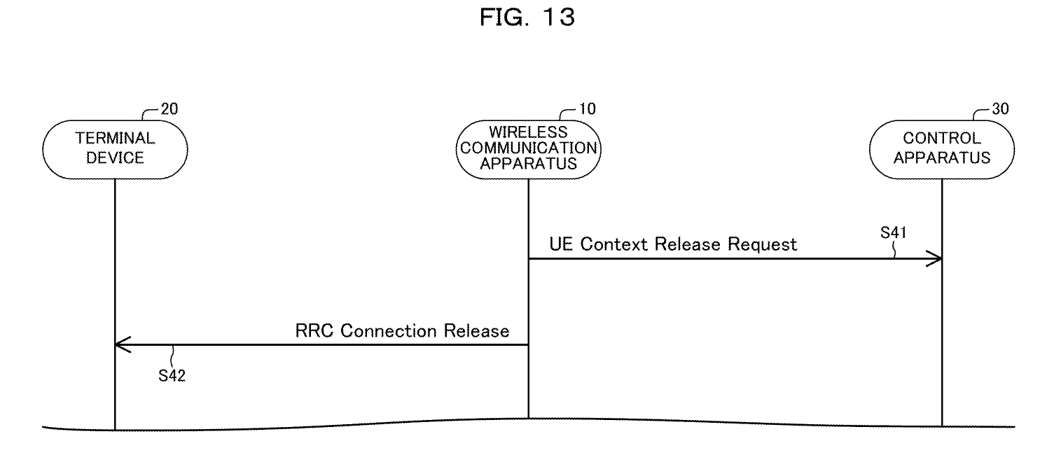

Furthermore, in this example, in the wireless communication system 1, a wireless communication apparatus 10 spontaneously disconnects a connection to a terminal device 20, with an execution of the procedure depicted in FIG. 13.

In this example, the wireless communication apparatus 10 sends a UE Context Release Request message to the control apparatus 30 (Step S41 in FIG. 13). In this example, the UE Context Release Request message includes disconnection cause information

The wireless communication apparatus 10 sends an RRC Connection Release message to the terminal device 20 (Step S42 in FIG. 13).

In this manner, the spontaneous disconnection of the connection by the wireless communication apparatus 10 is completed.

In this example, every time a UE Context Release Request message is sent to the control apparatus 30, the inferencer 105 obtains disconnection cause information included in the message that is sent.

In this example, connection information for a connection having a delay tolerant access as its cause, includes an HO disconnection ratio and a round-trip HO ratio.

An HO disconnection ratio is the ratio of the number of connections disconnected due to HOs in a cell formed by the wireless communication apparatus 10 having the inferencer 105, to the number of disconnected connections in that cell.

A round-trip HO ratio is the ratio of the number of HOs that are executed repeatedly between the cell formed by the wireless communication apparatus 10 having the inferencer 105 and another cell, to the number of HOs that are executed.

Here, it can be regarded that connection information is statistics of connections between the wireless IF processor 101 and terminal devices 20 in the cell.

The inferencer 105 counts the number of connections disconnected from which connection cause information has been obtained as a delay tolerant access (i.e., the total number of disconnections), and the number of connections disconnected due to HOs among those connections (i.e., the number of HO disconnections). In this example, a determination whether a connection is disconnected due to an HO or not is made based on disconnection cause information.

The inferencer 105 calculates the HO disconnection ratio by dividing the number of HO disconnections with the total number of disconnections.

The inferencer 105 also counts the number of history information of connections from which connection cause information has been obtained as a delay tolerant access (i.e., the total information count), and the number of history information that satisfies a round-trip HO condition among the history information (i.e., the round-trip HO information count).

In this example, history information includes information that identifies cells connected in the respective connections up to the third last connection.

In this example, the round-trip HO condition is the condition where the cell connected upon the last connection and the cell connected upon the third last connection are a first cell, and the cell connected upon the second last connection is a second cell. Here, the first cell is not the one formed by the wireless communication apparatus 10 having the inferencer 105. The second cell is the one formed by the wireless communication apparatus 10 having the inferencer 105.

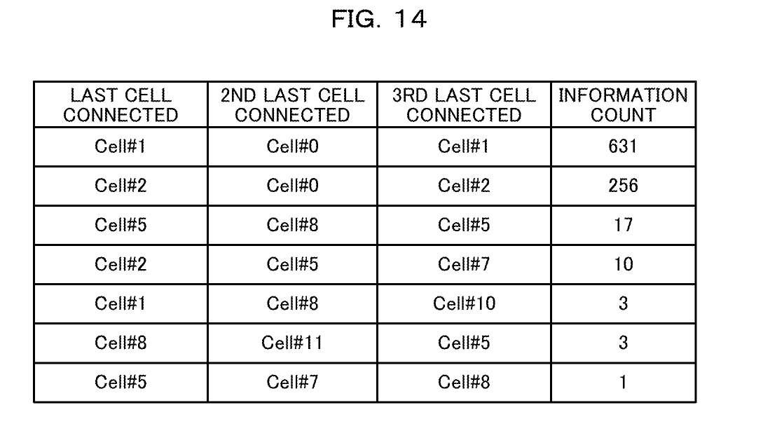

For example, as depicted in FIG. 14, it is assumed that history information is obtained for each combination of cells connected in the respective connections up to the third last connection. The cell connected upon the k^{th} last connection may also be referred to as the k^{th} last connection cell. k is each integer from 1 to 3. The number of history information obtained may also be referred to as the information count.

In FIG. 14, it is assumed that a cell identifier identifying the cell formed by the wireless communication apparatus 10 having the inferencer 105 is “Cell#0”. In this case, the inferencer 105 calculates the round-trip HO information count as 887 (=631 +256). The inferencer 105 calculates the total information count as 921(=631+256+17 +10+3+3+1).

The inferencer 105 calculates the round-trip HO ratio by dividing the round-trip HO information count with the total information count.

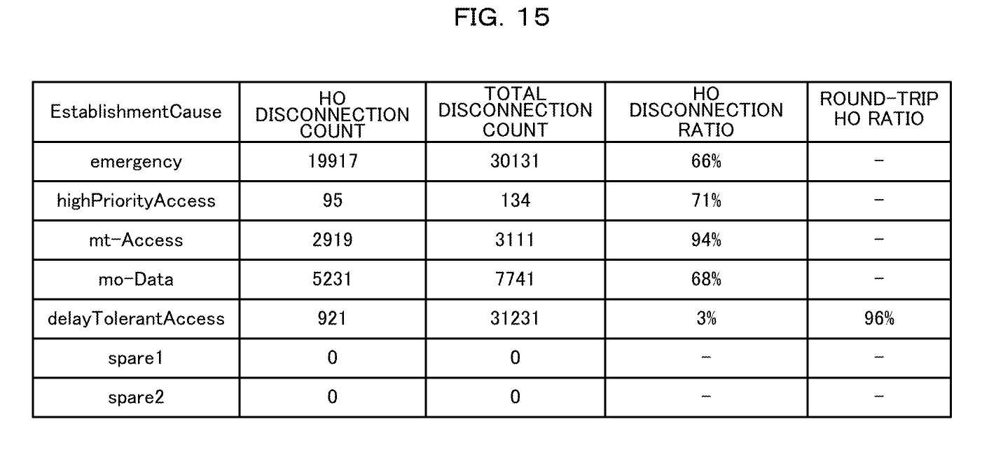

As described above, in this example, the inferencer 105 obtains an HO disconnection ratio and a round-trip HO ratio for each entry of “EstablishmentCause”, as depicted in FIG. 15. Note that the inferencer 105 may not obtain an HO disconnection ratio and a round-trip HO ratio for connections the “EstablishmentCause” of which is not “delayTolerantAccess”.

In addition to or in place of an HO disconnection ratio and a round-trip HO ratio, connection information may include a parameter indicating the status of a communication on a connection having a delay tolerant access as its cause.

Such a parameter indicating the status of a communication on a connection may include at least one of the average resource usage, the average bearer usage count, the average communication data volume, the average communication data rate, and the average communication time ratio.

The average resource usage is the average of the volume of a wireless resource used in a single connection, for connections in the local cell. The local cell is the one formed by the wireless communication apparatus 10 having the inferencer 105. The volume of a wireless resource may be a resource block count, for example.

The average bearer usage count is the average of the number of bearers used in a single connection, for connections in the local cell. For example, the bearer is an E-UTRAN radio access bearer (E-RAB).

The average communication data volume is the average of a data volume communicated through a single connection, for connections in the local cell.

The average communication data rate is the average of a data volume communicated per unit time through a single connection, for connections in the local cell.

The average communication time ratio is the average of a ratio of a time duration during which data is communicated through a single connection, to a time duration during which a communication can be carried out through that connection, for connections in the local cell.

It is to be noted that the connection information may be information about connections having any cause, irrespective of whether the cause is a delay tolerant access or not.

(Inference of Type of Terminal Device 20)

Next, an inference of the type of a terminal device 20 will be described.

It is highly probable that a connection having a delay tolerant access as its cause is carried out by an M2M device. Nevertheless, a connection having a delay tolerant access as its cause may be carried out by non-M2M terminal devices 20. Accordingly, in this example, the inferencer 105 infers the type of a terminal device 20 requesting a new connection based on connection information, in addition to the cause of the connection.

The inferencer 105 infers that the type of a terminal device 20 requesting a new connection is an M2M device when both a first condition (described later) and a second condition (described later) are satisfied, and when both the first condition (described later) and the third condition (described later) are satisfied.

In contrast, the inferencer 105 infers that the type of a terminal device 20 requesting a new connection is a mobile telephone, when the first condition (described later) is not satisfied, or when none of the second condition (described later) and the third condition (described later) is satisfied.

The first condition is the condition where the cause of a new connection by a terminal device 20 is a delay tolerant access.

The second condition is the condition where the HO disconnection ratio is equal to or less than a certain first threshold.

The third condition is the condition where the round-trip HO ratio is equal to or greater than a certain second threshold.

An update of connection information with the change in the ratio of the number of M2M devices connected to a wireless communication apparatus 10 to the number of terminal devices 20 connected to that wireless communication apparatus 10 is more delayed, as a time duration during which source information of connection information is obtained. An update of connection information with the change in the statuses of communications in the cell is more delayed, as a time duration during which the source information of the connection information is obtained.

Hence, the inferencer 105 may obtain information for connections in a time duration of a certain length, based on the connection information. The inferencer 105 may recalculate the counts for obtaining connection information (e.g., the total number of disconnections and the number of HO disconnections) by setting a value of “0” at every time interval.

Next, a control on communications between a wireless communication apparatus 10, and a terminal device 20 requesting a new connection to that wireless communication apparatus 10, will be described.

The controller 104 controls communications with the terminal device 20 requesting a new connection, based on a result of an inference by the inferencer 105.

In this example, the control on communications is achieved by setting wireless parameters.

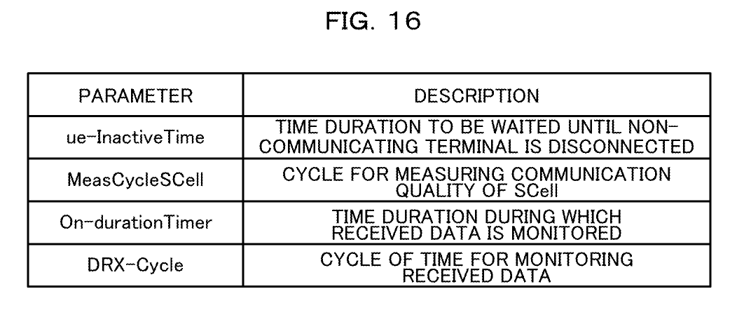

In this example, the wireless parameters include the ue-InactiveTime, the MeasCycleSCell, the On-durationTimer, and the DRX-Cycle, as depicted in FIG. 16.

The ue-InactiveTime indicates the time duration to be waited before disconnecting a connection to a terminal device 20 with which the wireless communication apparatus 10 does not communicate. The time indicated by the ue-InactiveTime represents one example of a time duration during which a connection of the wireless communication apparatus 10 and the terminal device 20 is to be maintained.

The MeasCycleSCell indicates a cycle at which the terminal device 20 measures the communication quality of the SCell. The SCell is a secondary cell in carrier aggregation.

The On-durationTimer indicates a time duration during which the terminal device 20 monitors receipt of data. Data to be received is notification information or a paging signal, for example.

The DRX-Cycle indicates a cycle at which the terminal device 20 monitors receipt of data.

The cycle indicated by the MeasCycleSCell, the time duration indicated by the On-durationTimer, and the cycle indicated by the DRX-Cycle represent examples the time duration during which the terminal device 20 operates.

When the inferencer 105 infers that the terminal device 20 requesting a new connection is an M2M device, the controller 104 sets a first time duration to the ue-InactiveTime. The first time duration is several seconds, for example.

Otherwise, when the inferencer 105 infers that the terminal device 20 requesting a new connection is a mobile telephone, the controller 104 sets a second time duration to the ue-InactiveTime. In this example, the second time duration is longer than the first time duration. The second time duration is a time duration of several minutes or longer, for example.

Communication inactive time of M2M devices is generally longer than that of mobile telephones. Thus, the wireless resource may be wasted by a connection to an M2M device that remains inactive. In contrast, since the controller 104 disconnects an inactive connection to an M2M device more swiftly, effective utilization of wireless resources can be achieved.

Furthermore, when the inferencer 105 infers that the terminal device 20 requesting a new connection is an M2M device, the controller 104 sets a first cycle to the MeasCycleSCell. The first cycle is the upper limit of a certain time range (i.e., a first time range).

Otherwise, when the inferencer 105 infers that the terminal device 20 requesting a new connection is a mobile telephone, the controller 104 sets a second cycle to the MeasCycleSCell. In this example, the second cycle is shorter than the first cycle. In this example, the second cycle is a value smaller than the upper limit of the first time range.

M2M devices generally communicate smaller data volumes per unit time than mobile telephones. Thus, the M2M devices carry out communications without carrier aggregation. Thus, the M2M devices generally unnecessarily measure the communication quality. In contrast, since the controller 104 reduces the frequency of measurements of the communication quality by the M2M devices, the power consumed by M2M devices (i.e., power consumptions) can be reduced.

Furthermore, when the inferencer 105 infers that the terminal device 20 requesting a new connection is an M2M device, the controller 104 sets a third time duration to the On-durationTimer. The third time duration is the lower limit of a certain time range (i.e., a second time range).

Otherwise, when the inferencer 105 infers that the terminal device 20 requesting a new connection is a mobile telephone, the controller 104 sets a fourth time duration to the On-durationTimer. In this example, the fourth time duration is longer than the third time duration. In this example, the fourth time duration is a value longer than the lower limit in the second time range.

M2M devices generally receive data less frequently than mobile telephones. Thus, the M2M devices generally monitor receipt of data longer than needed. In contrast, since the controller 104 shortens the time duration for monitoring receipt of data by the M2M devices, a reduction in power consumption by a M2M device can be achieved.

Furthermore, when the inferencer 105 infers that the terminal device 20 requesting a new connection is an M2M device, the controller 104 sets a third cycle to the DRX-Cycle. The third cycle is the upper limit of a certain time range (i.e., a third time range).

Otherwise, when the inferencer 105 infers that the terminal device 20 requesting a new connection is a mobile telephone, the controller 104 sets a fourth cycle to the DRX-Cycle. In this example, the fourth cycle is shorter than the third cycle. In this example, the fourth cycle is a value shorter than the upper limit of the third time range.

M2M devices generally receive data less frequently than mobile telephones. Thus, the M2M devices generally monitor receipt of data longer than needed. In contrast, the controller 104 reduces the frequency of monitor of receipt of data by the M2M devices, a reduction in power consumption by a M2M device can be achieved.

It is to be noted that the wireless parameters set for a terminal device 20 that is inferred as a mobile telephone may also be referred to as mobile telephone parameters. The wireless parameters set for a terminal device 20 that is inferred as an M2M device may also be referred to as M2M device parameters.

It is to be noted that wireless parameters may be some of parameters depicted in FIG. 16.

The wireless parameters may not be those in FIG. 16. For example, wireless parameters may include a first parameter indicating a cycle at which a terminal device 20 measures the quality communication in a cell.

In this case, when the inferencer 105 infers that the terminal device 20 requesting a new connection is an M2M device, the controller 104 sets a fifth cycle to the first parameter. Otherwise, when the inferencer 105 infers that the terminal device 20 requesting a new connection is a mobile telephone, the controller 104 sets a sixth cycle to the first parameter. In this example, the sixth cycle is shorter than the fifth cycle. Since this reduces the frequency of measurements of the communication quality by an M2M device, a reduction in power consumption by that M2M device can be achieved.

The wireless parameters may also include a second parameter indicating a cycle at which a terminal device 20 reports (e.g., sends) a measurement result of the communication quality in a cell, for example. The second parameter may also be referred to as the Reportlnterval.

In this case, when the inferencer 105 infers that the terminal device 20 requesting a new connection is an M2M device, the controller 104 sets a seventh cycle to the second parameter. Otherwise, when the inferencer 105 infers that the terminal device 20 requesting a new connection is a mobile telephone, the controller 104 sets an eighth cycle to the second parameter. In this example, the eighth cycle is shorter than the seventh cycle. Since this reduces the frequency of reports of the measurement result of the communication quality by an M2M device, a reduction in power consumption by that M2M device can be achieved.

The wireless parameters may also include a third parameter used to determine whether or not a terminal device 20 reports (e.g., sends) a measurement result of the communication quality in a cell, for example. The third parameter may also be referred to as the ThresholdEUTRA.

For example when the communication quality is lower than the third parameter, the terminal device 20 reports the measurement result of the communication quality.

In this case, when the inferencer 105 infers that the terminal device 20 requesting a new connection is an M2M device, the controller 104 sets a first value to the third parameter. Otherwise, when the inferencer 105 infers that the terminal device 20 requesting a new connection is a mobile telephone, the controller 104 sets a second value to the third parameter. In this example, the second value is greater than the first value. Since this reduces the frequency of reports of the measurement result of the communication quality by an M2M device, a reduction in power consumption by that M2M device can be achieved.

Otherwise, when the communication quality is higher than the third parameter, the terminal device 20 reports the measurement result of the communication quality, for example.

In this case, when the inferencer 105 infers that the terminal device 20 requesting a new connection is an M2M device, the controller 104 sets a third value to the third parameter. Otherwise, when the inferencer 105 infers that the terminal device 20 requesting a new connection is a mobile telephone, the controller 104 sets a fourth value to the third parameter. In this example, the fourth value is smaller than the third value. Since this reduces the frequency of reports of the measurement result of the communication quality by an M2M device, a reduction in power consumption by that M2M device can be achieved.

The wireless parameter may also include a fourth parameter indicating the maximum number of cells for which the terminal device 20 reports measurement results of the communication quality, for example. The fourth parameter may also be referred to as the maxReportCells.

In this case, when the inferencer 105 infers that the terminal device 20 requesting a new connection is an M2M device, the controller 104 sets a fifth value to the fourth parameter. Otherwise, when the inferencer 105 infers that the terminal device 20 requesting a new connection is a mobile telephone, the controller 104 sets a sixth value to the fourth parameter. In this example, the sixth value is greater than the fifth value. Since this reduces the data volumes of measurement results of the communication quality sent by the M2M device, a reduction in power consumption by that M2M device can be achieved.

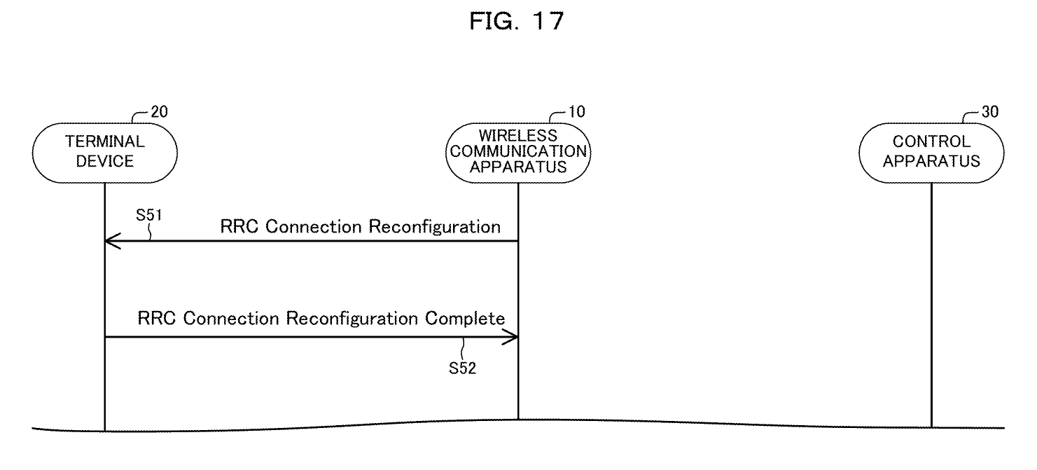

In this example, in the wireless communication system 1, the wireless parameters for a terminal device 20 are set by a wireless communication apparatus 10 with an execution of the procedure depicted in FIG. 17. For example, the procedure depicted in FIG. 17 may be executed after the procedure depicted in FIG. 8.

In this example, the wireless communication apparatus 10 sends an RRC Connection Reconfiguration message to the terminal device 20 (Step S51 in FIG. 17). In this example, the RRC Connection Reconfiguration message includes communication parameters.

The terminal device 20 sends an RRC Connection Reconfiguration Complete message to the wireless communication apparatus 10 (Step S52 in FIG. 17).

In this manner, the setting of the wireless parameters for the terminal devices 20 is completed.

(Operations)

One example of the wireless communication system 1 will be described.

In this example, it is assumed that the first threshold for the HO disconnection ratio is 5%, and the second threshold for the round-trip HO ratio is 99%.

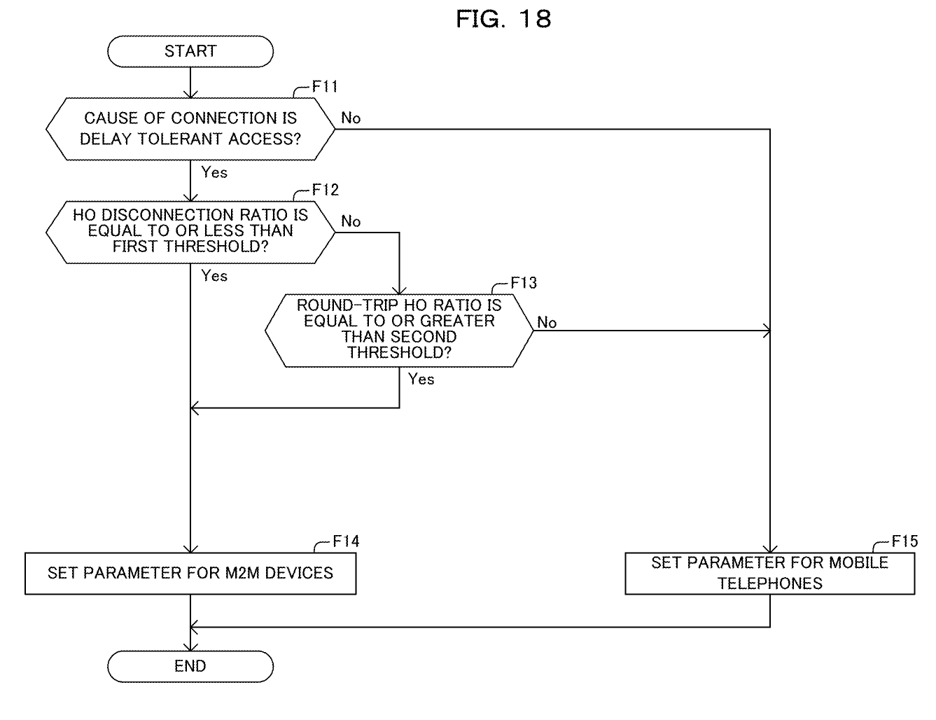

In this example, a wireless communication apparatus 10 executes the processing depicted in FIG. 18, every time a terminal device 20 is newly connected to that wireless communication apparatus 10.

First, a case will be described wherein a terminal device 20 requesting a new connection is a mobile telephone.

In this case, the wireless communication apparatus 10 determines whether or not the cause of a connection is a delay tolerant access (Step F11 in FIG. 18).

On the above assumption, the value of the “EstablishmentCause” included in the RRC Connection Request message sent from the terminal device 20 to the wireless communication apparatus 10 is “mo-Data”. Hence, the wireless communication apparatus 10 makes a “No” decision in Step F11, and sets mobile telephone parameters to the wireless parameters of the terminal device 20 requesting a new connection to that wireless communication apparatus 10 (Step F15 in FIG. 18). The wireless communication apparatus 10 then terminates the processing depicted in FIG. 18.

Next, a case will be described wherein a terminal device 20 requesting a new connection is an M2M device, and the HO disconnection ratio included in the connection information is equal to or less than a first threshold. It is assumed that the HO disconnection ratio is 3%, for example.

In this case, the value of the “EstablishmentCause” included in the RRC Connection Request message sent from the terminal device 20 to the wireless communication apparatus 10 is “delayTolerantAccess”. Hence, when the processing proceeds to Step F11 in FIG. 18, the wireless communication apparatus 10 makes a “Yes” decision, and determines whether or not the HO disconnection ratio included in the connection information is equal to or less than the first threshold (Step F12 in FIG. 18).

On the above assumption, the HO disconnection ratio included in the connection information is equal to or less than the first threshold. Hence, the wireless communication apparatus 10 makes a “Yes” decision in Step F12, and sets M2M device parameters to the wireless parameters of the terminal device 20 requesting a new connection to that wireless communication apparatus 10 (Step F14 in FIG. 18). The wireless communication apparatus 10 then terminates the processing depicted in FIG. 18.

Next, a case will be described wherein a terminal device 20 requesting a new connection is an M2M device, and the HO disconnection ratio included in the connection information is greater than the first threshold, and the round-trip HO ratio included in the connection information is equal to or greater than a second threshold. It is assumed that the HO disconnection ratio is 8%, and the round-trip HO ratio is 96%, for example.

In this case, the value of the “EstablishmentCause” included in the RRC Connection Request message sent from the terminal device 20 to the wireless communication apparatus 10 is “delayTolerantAccess”. Hence, when the processing proceeds to Step F11 in FIG. 18, the wireless communication apparatus 10 makes a “Yes” decision.

Furthermore, in this case, the HO disconnection ratio included in the connection information is greater than the first threshold. Hence, when the processing proceeds to Step F12 in FIG. 18, the wireless communication apparatus 10 makes a “No” decision, and determines whether or not the round-trip HO ratio included in the connection information is equal to or greater than the second threshold (Step F13 in FIG. 18).

On the above assumption, the round-trip HO ratio included in the connection information is smaller than the second threshold. Hence, the wireless communication apparatus 10 makes a “No” decision in Step F13, and sets mobile telephone parameters to the wireless parameters of the terminal device 20 requesting a new connection to that wireless communication apparatus 10 (Step F15 in FIG. 18). The wireless communication apparatus 10 then terminates the processing depicted in FIG. 18.

Next, a case will be described wherein a terminal device 20 requesting a new connection is an M2M device, and the HO disconnection ratio included in the connection information is greater than the first threshold and the round-trip HO ratio included in the connection information is equal to or greater than a second threshold. It is assumed that the HO disconnection ratio is 8%, and the round-trip HO ratio is 99%, for example.

In this case, the value of the “EstablishmentCause” included in the RRC Connection Request message sent from the terminal device 20 to the wireless communication apparatus 10 is the “delayTolerantAccess”. Hence, when the processing proceeds to Step F11 in FIG. 18, the wireless communication apparatus 10 makes a “Yes” decision.

Furthermore, in this case, the HO disconnection ratio included in the connection information is greater than the first threshold. Hence, when the processing proceeds to Step F12 in FIG. 18, the wireless communication apparatus 10 makes a “No” decision. Further, in this case, the round-trip HO ratio included in the connection information is equal to or greater than the second threshold. Hence, when the processing proceeds to Step F13 in FIG. 18, the wireless communication apparatus 10 makes a “Yes” decision.

The wireless communication apparatus 10 then sets M2M device parameters to wireless parameters of the terminal device 20 requesting a new connection to that wireless communication apparatus 10 (Step F14 in FIG. 18). The wireless communication apparatus 10 then terminates the processing depicted in FIG. 18.

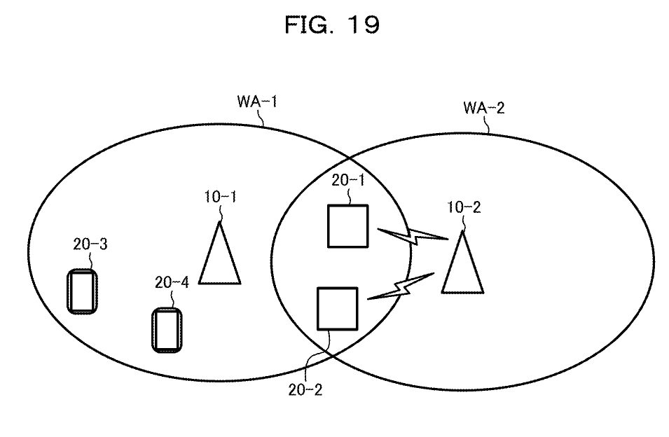

Next, a case will be described wherein the relationship between a cell formed by a wireless communication apparatus 10 and a cell adjacent to that cell changes. A part of a cell is included within another cell is one example of cells adjoining each other. In this example, it is assumed that a cell WA-1 formed by a wireless communication apparatus 10-1 and a cell WA-2 formed by a wireless communication apparatus 10-2 adjoin each other, as depicted in FIG. 19.

It is also assumed that terminal devices 20-3 and 20-4 that are mobile telephones are connected to the wireless communication apparatus 10-1, and terminal devices 20-1 and 20-2 that are M2M devices are connected to the wireless communication apparatus 10-2. The terminal devices 20-1 and 20-2 that are M2M devices are covered by the cell WA-1.

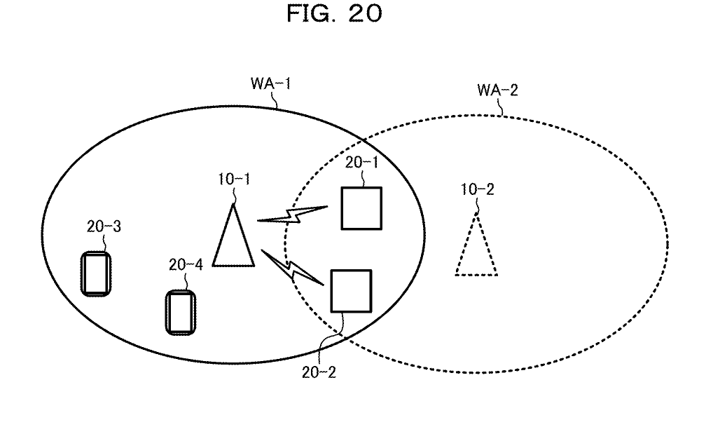

It is also assumed that the wireless communication apparatus 10-2 stops its operation (e.g., the wireless communication apparatus 10-2 is removed from the wireless communication system 1), as depicted in FIG. 20, after the numbers to be counted for collecting connection information are set to “0”. In this example, the numbers to be counted for collecting the connection information are the total number of disconnections, the number of HO disconnections, and the number of history information.

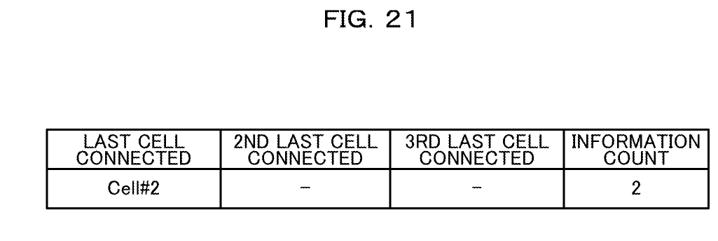

In this case, an HO from the wireless communication apparatus 10-2 to the wireless communication apparatus 10-1 causes the terminal devices 20-1 and 20-2 that are M2M devices, to be newly connected to the wireless communication apparatus 10-1. In this case, as depicted in FIG. 21, the last connection cell is “Cell#2”, the second last and the third last connection cells are not present, and the number of history information (i.e., information count) is “2”. In this example, the “Cell#2” is an identifier identifying the cell WA-2.

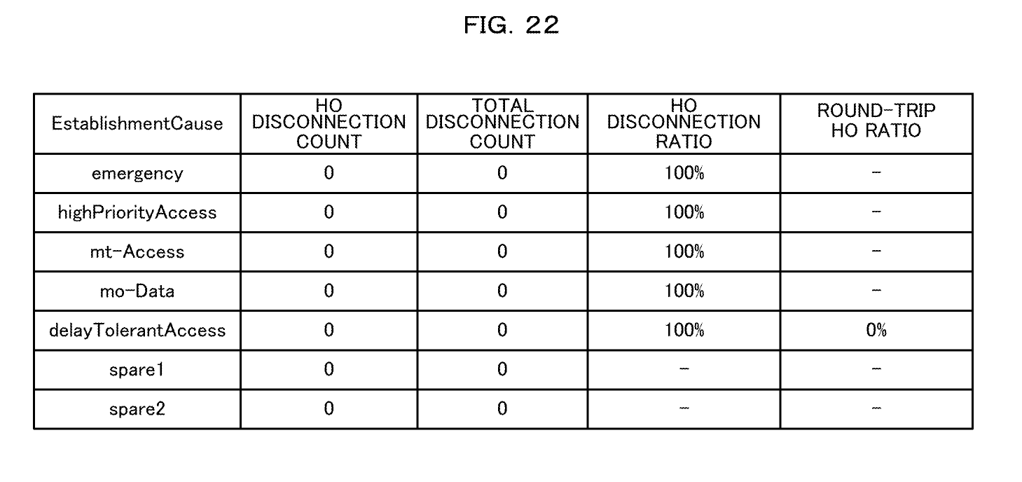

Hence, the wireless communication apparatus 10-1 counts “0” for the round-trip HO information count, and “2” for the total information count. In this example, as depicted in FIG. 22, the wireless communication apparatus 10-1 counts “0” for the number of HO disconnections and the total number of disconnections, for each cause of a connection.

In this example, when the total number of disconnections is “0”, the wireless communication apparatus 10-1 sets a value greater than the first threshold (100%, in this example), to the HO disconnection ratio. Hence, the wireless communication apparatus 10-1 obtains the HO disconnection ratio of 100% and the round-trip HO ratio of 0%, for a connection having a delay tolerant access as its cause.

Hence, the wireless communication apparatus 10-1 makes a “Yes” decision in Step F11 in FIG. 18, makes a “No” decision in Step F12 in FIG. 18, and makes a “No” decision in FIG. 18 Step F13. The wireless communication apparatus 10-1 then sets mobile telephone parameters, to the wireless parameters of the terminal devices 20-1 and 20-2 newly requesting a connection to the wireless communication apparatus 10-1 (in FIG. 18 Step F15).

Thereafter, when the communication inactive time of the terminal devices 20-1 and 20-2 exceeds the time duration set in the ue-InactiveTime, the wireless communication apparatus 10-1 disconnects the connections to the terminal devices 20-1 and 20-2. This increases the total number of disconnections, but does not increase the number of HO disconnections.

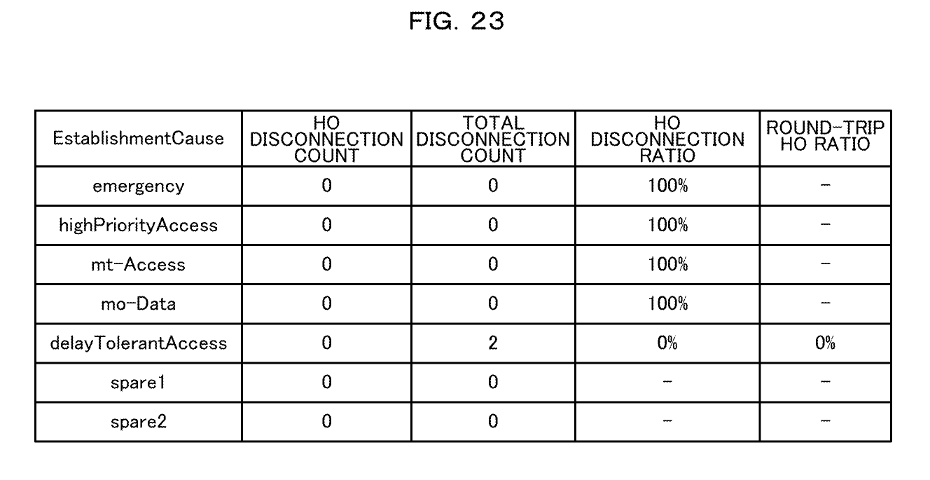

For example, as depicted in FIG. 23, when the total number of disconnections changes to “2”, the wireless communication apparatus 10-1 obtains the HO disconnection ratio of 0%, for a connection having a delay tolerant access as its cause.

Accordingly, when the terminal devices 20-1 and 20-2 newly connect to the wireless communication apparatus 10-1 once again, the wireless communication apparatus 10-1 makes a “Yes” decision in Step F11 in FIG. 18 and makes a “Yes” decision in Step F12 in FIG. 18. The wireless communication apparatus 10-1 then sets M2M device parameters to the wireless parameters of the terminal devices 20-1 and 20-2 newly requesting a connection to the wireless communication apparatus 10-1 (Step F15 in FIG. 18).

As set forth above, a wireless communication apparatus 10 of the first embodiment infers the type of a terminal device 20 requesting a new connection, based on information obtained from previous connections in a wireless area. The wireless communication apparatus 10 controls communications with that terminal device 20, based on the inferred type.

Information obtained from previous connections in the wireless area correlates with the probability of the terminal device 20 requesting a new connection being an M2M device in that wireless area. Hence, in accordance with the wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

Furthermore, in a wireless communication apparatus 10 of the first embodiment, information obtained from previous connections in the wireless area includes the HO disconnection ratio. Additionally, the wireless communication apparatus 10 infers that a terminal device 20 requesting a new connection is an M2M device when the HO disconnection ratio is equal to or less than the first threshold.

For example, the HO disconnection ratio in a wireless area decreases with an increase in the ratio of the number of stationery terminal devices 20 to the number of terminal devices 20 present in that wireless area. The probability of the terminal device 20 requesting a new connection being an M2M device is increased with a decline in the HO disconnection ratio. Hence, in accordance with the wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

Furthermore, in a wireless communication apparatus 10 of the first embodiment, information obtained from previous connections in the wireless area includes the round-trip HO ratio. Additionally, the wireless communication apparatus 10 infers that a terminal device 20 requesting a new connection is an M2M device, when the HO disconnection ratio is greater than a first threshold and the round-trip HO ratio is equal to or greater than a second threshold.

For example, when a terminal device 20 is located on a border of wireless areas, HOs may be repeatedly executed between those wireless areas. In this case, in general, the HO disconnection ratio is increased and the round-trip HO ratio is also increased. Accordingly, even when the HO disconnection ratio is greater than the first threshold, the probability of the terminal device 20 requesting a new connection being an M2M device is increased with an increase in the round-trip HO ratio.

Hence, in accordance with the wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

Furthermore, a wireless communication apparatus 10 of the first embodiment infers that a terminal device 20 requesting a new connection is an M2M device, when the cause of a new connection is a delay tolerant access.

When a cause of a connection is a delay tolerant access, it is highly probable that an M2M device carried out that connection. Hence, in accordance with the wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

Furthermore, when a wireless communication apparatus 10 of the first embodiment infers that a terminal device 20 requesting a new connection is an M2M device, communications with the terminal device 20 requesting a new connection are controlled in accordance with a certain control scheme. The control scheme is defined such that at least one of a time to maintain the connection and a time to operate the terminal device 20 is shorter than the corresponding one when the terminal device 20 requesting a new connection is inferred as a non-M2M device.

This can shorten the time to maintain the connection, when the terminal device 20 requesting a new connection is an M2M device. This facilitates effective utilization of wireless resources.

This can also shorten the time to operate the terminal device 20, when the terminal device 20 requesting a new connection is an M2M device. This helps to reduce the power consumption by the terminal device 20.

Furthermore, in a wireless communication apparatus 10 of the first embodiment, information obtained from previous connections in the wireless area is obtained from a connection having a delay tolerant access as its cause.

When a cause of a connection is a delay tolerant access, it is highly probable that an M2M device carried out that connection. Hence, information obtained from a connection having a delay tolerant access as its cause, of information obtained from previous connections in the wireless area, correlates with the probability of the terminal device 20 requesting a new connection being an M2M device.

Hence, in accordance with a wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

### Second Embodiment

Next, a wireless communication system in accordance with a second embodiment of the present disclosure will be described. The wireless communication system in accordance with the second embodiment is different from the wireless communication system in accordance with the first embodiment in that an average communication data volume is also used for an inference of the type of a terminal device. Description will be made focusing on the difference. Note that in the descriptions of the second embodiment, elements that are referenced to by the same reference symbols as those in the first embodiment denote the same or similar elements.

In this example, connection information includes a parameter indicating the status of a communication on a connection having a delay tolerant access as its cause, in addition to an HO disconnection ratio and a round-trip HO ratio. In this example, the parameter indicating the status of a communication on a connection includes an average communication data volume.

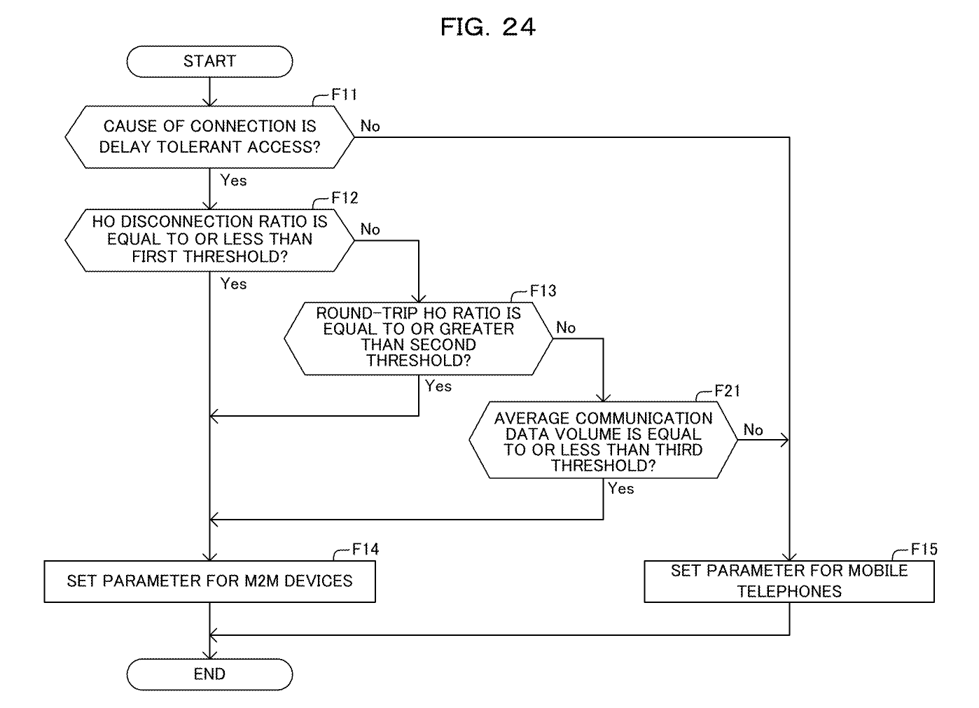

In this example, a wireless communication apparatus 10 executes the processing depicted in FIG. 24, in place of the processing depicted in FIG. 18. The processing in FIG. 24 includes an additional Step F21 on the “No” route from Step F13 in the processing in FIG. 18.

In this example, when a wireless communication apparatus 10 makes a “No” decision in Step F13 in FIG. 24, the wireless communication apparatus 10 determines whether or not the average communication data volume is equal to or less than a certain third threshold (Step F21 in FIG. 24).

When the average communication data volume is equal to or less than the third threshold, the wireless communication apparatus 10 makes a “Yes” decision and sets M2M device parameters to wireless parameters of a terminal device 20 requesting a new connection to that wireless communication apparatus 10 (Step F14 in FIG. 24).

Otherwise, when the average communication data volume is greater than the third threshold, the wireless communication apparatus 10 makes a “No” decision and sets mobile telephone parameters to the wireless parameters of the terminal device 20 requesting a new connection to that wireless communication apparatus 10 (Step F15 in FIG. 24).

As set forth above, in a wireless communication apparatus 10 of the second embodiment, information obtained from previous connections in the wireless area includes the average of data volume communicated through a single connection, for multiple connections. When the average is equal to or less than the third threshold, the wireless communication apparatus 10 infers that a terminal device 20 requesting a new connection is an M2M device.

M2M devices communicate smaller data volumes than terminal devices 20 that are not M2M devices. For example, the average data volume communicated is reduced with an increase in the ratio of the number of M2M devices to the number of terminal devices 20 present in a wireless area.

Hence, in accordance with a wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

It is to be noted that a wireless communication apparatus 10 may use an average resource usage or an average bearer usage count, in place of the average communication data volume.

### Third Embodiment

Next, a wireless communication system in accordance with a third embodiment of the present disclosure will be described. The wireless communication system in accordance with the third embodiment is different from the wireless communication system in accordance with the first embodiment in that an average communication data rate is also used for an inference of the type of a terminal device. Description will be made focusing on the difference. Note that in the descriptions of the third embodiment, elements that are referenced to by the same reference symbols as those in the first embodiment denote the same or similar elements.

In this example, connection information includes a parameter indicating the status of a communication on a connection having a delay tolerant access as its cause, in addition to an HO disconnection ratio and a round-trip HO ratio. In this example, the parameter indicating the status of a communication on a connection includes an average communication data rate.

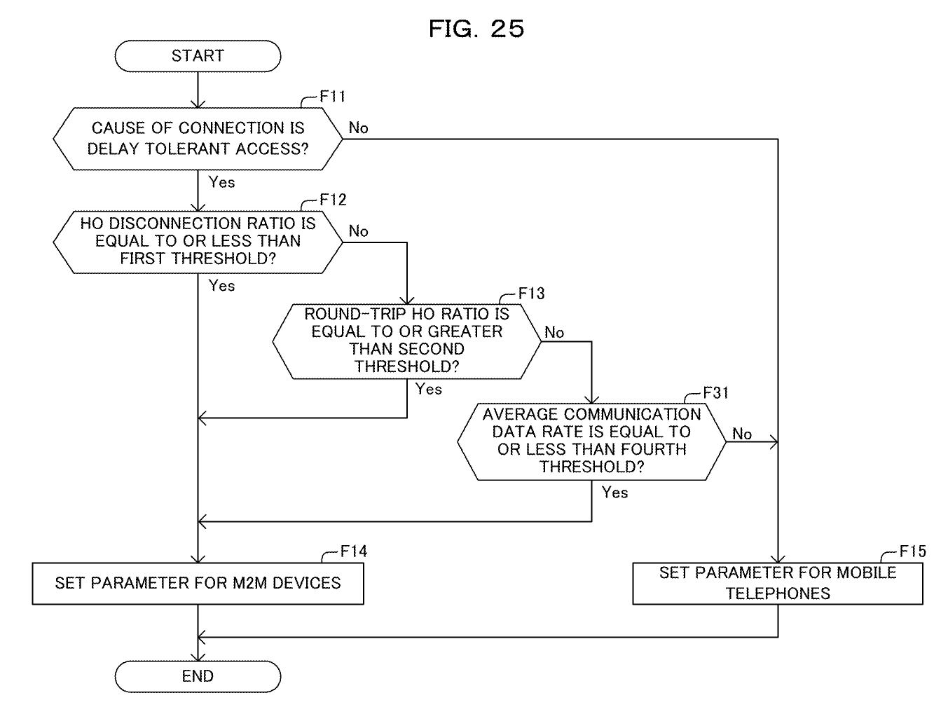

In this example, a wireless communication apparatus 10 executes the processing depicted in FIG. 25, in place of the processing depicted in FIG. 18. The processing in FIG. 25 includes an additional Step F31 on the “No” route from Step F13 in the processing in FIG. 18.

In this example, when a wireless communication apparatus 10 makes a “No” decision in Step F13 in FIG. 25, the wireless communication apparatus 10 determines whether or not the average communication data rate is equal to or less than a certain fourth threshold (Step F31 in FIG. 25).

When the average communication data rate is equal to or less than the fourth threshold, the wireless communication apparatus 10 makes a “Yes” decision and sets M2M device parameters to wireless parameters of a terminal device 20 requesting a new connection to that wireless communication apparatus 10 (Step F14 in FIG. 25).

Otherwise, when the average communication data rate is greater than the fourth threshold, the wireless communication apparatus 10 makes a “No” decision and sets mobile telephone parameters to the wireless parameters of the terminal device 20 requesting a new connection to that wireless communication apparatus 10 (Step F15 in FIG. 25).

As set forth above, in a wireless communication apparatus 10 of the third embodiment, information obtained from previous connections in the wireless area includes an average of a data volume communicated per unit time through a single connection, for multiple connections. When the average is equal to or less than the fourth threshold, the wireless communication apparatus 10 infers that a terminal device 20 requesting a new connection is an M2M device.

M2M devices generally communicate less data volume per unit time than terminal devices 20 that are not M2M devices. For example, the average data volume communicated per unit time is reduced with an increase in the ratio of the number of M2M devices to the number of terminal devices 20 present in a wireless area.

Hence, in accordance with a wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

### Fourth Embodiment

Next, a wireless communication system in accordance with a fourth embodiment of the present disclosure will be described. The wireless communication system in accordance with the fourth embodiment is different from the wireless communication system in accordance with the first embodiment in that an average communication time ratio is also used for an inference of the type of a terminal device. Description will be made focusing on the difference. Note that in the descriptions of the fourth embodiment, elements that are referenced to by the same reference symbols as those in the first embodiment denote the same or similar elements.

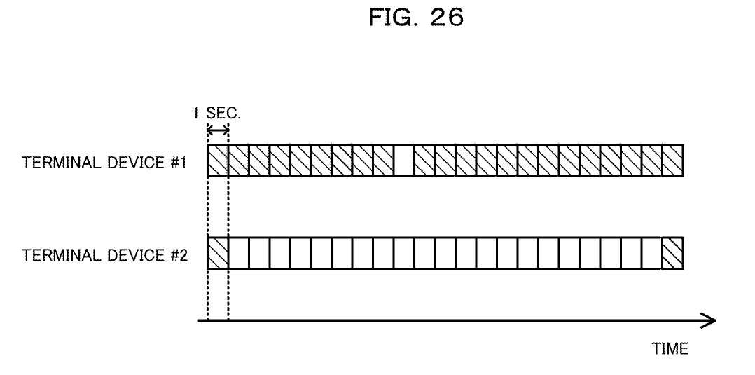

M2M devices generally experience longer communication inactive time than mobile telephones. For example, as depicted in FIG. 26, the communication inactive time of a terminal device #1 that is an M2M device is 22 seconds of 23 seconds, whereas the communication inactive time of a terminal device #2 that is a mobile telephone is two seconds of 23 seconds. In FIG. 26, the hatched rectangles indicate the time duration wherein no communication is carried out, whereas unhatched rectangles indicate the time duration wherein communications are carried out.

Hence, the ratio of a time duration during which data is communicated through a single connection, to a time duration during which a communication can be carried out through that connection correlates with the type of a terminal device 20 that makes that connection.

In this example, a wireless communication apparatus 10 obtains a communication time ratio for each terminal device 20, based on a measurement of a timer for measuring a time duration during which the terminal device 20 carries out no communication. Note that the timer may also be referred to as the UE Inactivity Timer, the User Inactivity Timer, the UE Inactive Timer, or the User Inactive Timer.

In this example, connection information includes a parameter indicating the status of a communication on a connection having a delay tolerant access as its cause, in addition to an HO disconnection ratio and a round-trip HO ratio. In this example, the parameter indicating the status of a communication on a connection includes an average communication time ratio.

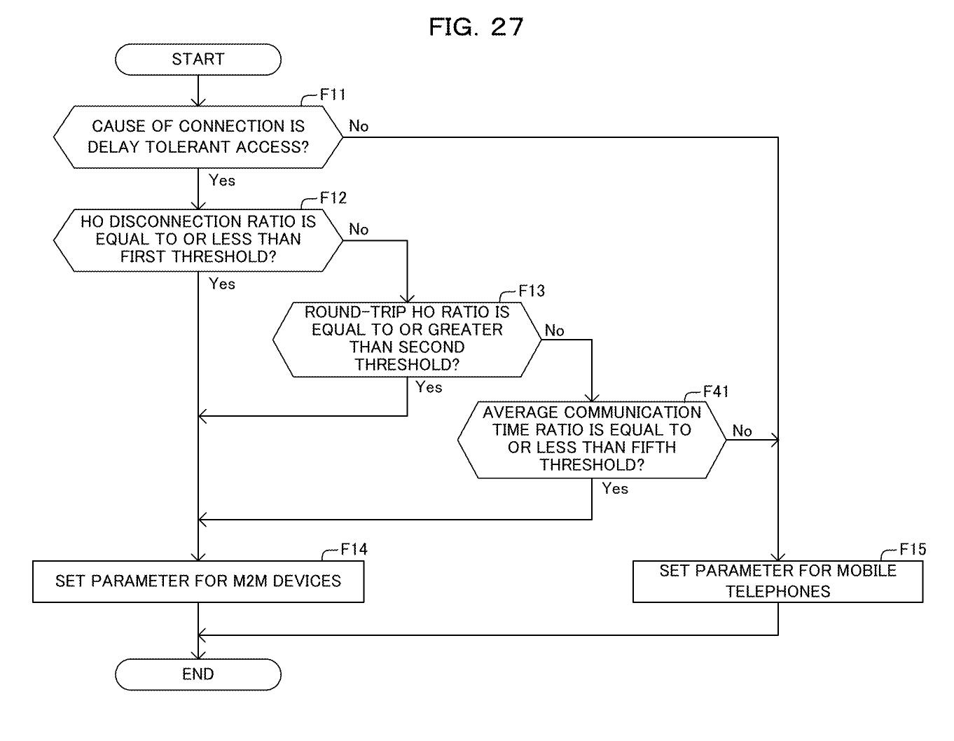

In this example, a wireless communication apparatus 10 executes the processing depicted in FIG. 27, in place of the processing depicted in FIG. 18. The processing in FIG. 27 includes an additional Step F41 on the “No” route from Step F13 in the processing in FIG. 18.

In this example, when a wireless communication apparatus 10 makes a “No” decision in Step F13 in FIG. 27, the wireless communication apparatus 10 determines whether or not the average communication time ratio is equal to or less than a certain fifth threshold (Step F41 in FIG. 27).

When the average communication time ratio is equal to or less than the fifth threshold when, the wireless communication apparatus 10 makes a “Yes” decision and sets M2M device parameters to wireless parameters of a terminal device 20 requesting a new connection to that wireless communication apparatus 10 (Step F14 in FIG. 27).

Otherwise, when the average communication time ratio is greater than the fifth threshold, the wireless communication apparatus 10 determines “No” and sets mobile telephone parameters to the wireless parameters of the terminal device 20 requesting a new connection to that wireless communication apparatus 10 (Step F15 in FIG. 27).

As set forth above, in a wireless communication apparatus 10 of the fourth embodiment, information obtained from previous connections in the wireless area includes the average of a ratio of a time duration during which data is communicated through a single connection, to a time duration during which a communication can be carried out through that connection, for a plurality of connections. When the average is equal to or less than the fifth threshold, the wireless communication apparatus 10 infers that a terminal device 20 requesting a new connection is an M2M device.

M2M devices generally experience lower ratios of a time duration during which data is communicated, to a time duration during which a communication can be carried out, than terminal devices 20 that are not M2M devices. For example, the average of the ratio of a time duration during which data is communicated, to a time duration during which a communication can be carried out, is reduced with an increase in the ratio of the number of M2M devices to the number of terminal devices 20 present in a wireless area.

Hence, in accordance with a wireless communication apparatus 10, the accuracy of inference of the type of a terminal device 20 requesting a new connection can be improved. This allows an appropriate control on communications between a wireless communication apparatus 10 and a terminal device 20, in accordance with the type of the terminal device 20. As a result, wireless communications can be carried out efficiently. For example, effective utilization of wireless resources can be achieved. A reduction in the power consumption by terminal devices 20 can also be achieved, for example.

It is to be noted that a wireless communication apparatus 10 may use an average communication inactive time ratio, in place of the average communication time ratio. The average communication inactive time ratio is the average of a ratio of a time duration during which no data is communicated through a single connection, to a time duration during which a communication can be carried out through that connection, for connections in the local cell.

Wireless communications can be carried out efficiently.

All examples and conditional language provided herein are intended for pedagogical purposes of aiding the reader in understanding the invention and the concepts contributed by the inventor to furthering the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communication apparatus adapted to provide a wireless area, comprising:
an inferencer adapted to infer a type of a terminal device that is requesting a new connection, based on information obtained through a previous connection in the wireless area; and
a controller adapted to control a communication with the terminal device based on the inferred type.

2. The wireless communication apparatus according to claim 1, wherein
the information includes a handover disconnection ratio that is a ratio of a number of connections disconnected due to handovers in the wireless area, to a number of disconnected connections in the wireless area, and
the inferencer infers that the terminal device is a machine-to-machine (M2M) device, when the handover disconnection ratio is equal to or less than a first threshold.

3. The wireless communication apparatus according to claim 2, wherein
the information includes a round-trip handover ratio that is a ratio of a number of repeated handovers performed between the wireless area and another wireless area, to a number of handovers performed, and
the inferencer infers that the terminal device is the machine-to-machine (M2M) device, when the handover disconnection ratio is greater than the first threshold and the round-trip handover ratio is equal to or greater than a second threshold.

4. The wireless communication apparatus according to claim 1, wherein
the information includes an average of a data volume communicated through a single connection, for a plurality of connections, and
the inferencer infers that the terminal device is the machine-to-machine (M2M) device when the average is equal to or less than a third threshold.

5. The wireless communication apparatus according to claim 1, wherein
the information includes an average of a data volume communicated per unit time through a single connection, for a plurality of connections, and
the inferencer infers that the terminal device is the machine-to-machine (M2M) device, when the average is equal to or less than a fourth threshold.

6. The wireless communication apparatus according to claim 1, wherein
the information includes an average of a ratio of a time duration during which data is communicated through a single connection, to a time duration during which a communication can be carried out through the single connection, for a plurality of connections, and
the inferencer infers that the terminal device is the machine-to-machine (M2M) device, when the average is equal to or less than a fifth threshold.

7. The wireless communication apparatus according to claim 1, wherein
the inferencer infers that the terminal device is the machine-to-machine (M2M) device, when a cause of the new connection is a delay tolerant access.

8. The wireless communication apparatus according to claim 1, wherein
when it is inferred that the terminal device is the machine-to-machine (M2M) device, the controller controls the communication with the terminal device such that at least one of a time duration during which the connection is maintained and a time duration during which the terminal device is operated, becomes shorter than a corresponding time duration when it is inferred that the terminal device is a non-M2M device.

9. The wireless communication apparatus according to claim 1, wherein
the information is obtained through connection, a cause of which is a delay tolerant access.

10. A method of controlling a wireless communication apparatus adapted to provide a wireless area, the method comprising:
inferring a type of a terminal device that is requesting a new connection, based on information obtained through a previous connection in the wireless area; and
controlling a communication with the terminal device based on the inferred type.

11. The method according to claim 10, wherein
the information includes a handover disconnection ratio that is a ratio of a number of connections disconnected due to handovers in the wireless area, to a number of disconnected connections in the wireless area, and
the inferring comprises inferring that the terminal device is a machine-to-machine (M2M) device, when the handover disconnection ratio is equal to or less than a first threshold.

12. The method according to claim 11, wherein
the information includes a round-trip handover ratio that is a ratio of a number of repeated handovers performed between the wireless area and another wireless area, to a number of handovers performed, and
the inferring comprises inferring that the terminal device is the machine-to-machine (M2M) device, when the handover disconnection ratio is greater than the first threshold and the round-trip handover ratio is equal to or greater than a second threshold.

13. A wireless communication system comprising:
a wireless communication apparatus adapted to provide a wireless area;
a terminal device adapted to wirelessly communicate to the wireless communication apparatus, by being connected with the wireless communication apparatus, in the wireless area;
an inferencer adapted to infer a type of the terminal device that is requesting a new connection, based on information obtained through a previous connection in the wireless area; and
a controller adapted to control a communication with the terminal device based on the inferred type.

14. The wireless communication system according to claim 13, wherein
the information includes a handover disconnection ratio that is a ratio of a number of connections disconnected due to handovers in the wireless area, to a number of disconnected connections in the wireless area, and
the inferencer infers that the terminal device is a machine-to-machine (M2M) device, when the handover disconnection ratio is equal to or less than a first threshold.

15. The wireless communication system according to claim 14, wherein
the information includes a round-trip handover ratio that is a ratio of a number of repeated handovers performed between the wireless area and another wireless area, to a number of handovers performed, and
the inferencer infers that the terminal device is the machine-to-machine (M2M) device, when the handover disconnection ratio is greater than the first threshold and the round-trip handover ratio is equal to or greater than a second threshold.
